(19) United States
(12) Patent Application Publication
(10) Pub. No.: US 2026/0316525 A1
(43) Pub. Date: Oct. 15, 2026

(54) MODULAR HEAT EXCHANGE SYSTEM

(71) Applicants: HYUNDAI WIA Corporation, Changwon-si (KR); ESTRA AUTOMOTIVE SYSTEMS CO., LTD., Daegu (KR)

(72) Inventors: Hyung Seob KIM, Uiwang-si (KR); Jun Ho KIM, Uiwang-si (KR); Se Min LEE, Uiwang-si (KR); Sung Won Kang, Daegu (KR); Young Sam SIN, Daegu (KR); Jong Seok SHIN, Daegu (KR)

(73) Assignees: HYUNDAI WIA Corporation, Changwon-si, GY (KR); ESTRA AUTOMOTIVE SYSTEMS CO., LTD., Daegu, NG (KR)

(21) Appl. No.: 19/485,220

(22) PCT Filed: May 17, 2024
(86) PCT No.: PCT/KR2024/095821

§ 371 Date: Nov. 17, 2025

(30) Foreign Application Priority Data
May 17, 2023 (KR) 10-2023-0063870
May 17, 2024 (KR) 10-2024-0064380

(51) Int. Cl. B60H 1/32

(52) U.S. Cl. CPC B60H 1/3227; B60H 1/3228

(57) ABSTRACT

This modular heat exchange system is configured to perform heat exchange with a target medium through a flow of a refrigerant, and comprises a compressor, a condenser, an expansion device, and an evaporator such that a refrigerant circuit is formed. The expansion device comprises: an expansion valve configured to be able to expand the refrigerant; and a valve block formed in a block shape so as to form a channel such that, after passing through the condenser, the refrigerant is supplied to the evaporator via the expansion valve.

### TECHNICAL FIELD

The present disclosure relates to a heat exchange system for vehicles including a plurality of components for heat exchange, such as cooling, and more particularly to a modular heat exchange system in which a plurality of components is intensively installed on a support structure.

### BACKGROUND ART

Pure electric vehicles using batteries as power sources and so-called hybrid electric vehicles using both batteries and internal combustion engines as power sources are commonly referred to as electric vehicles. A heat exchange system for electric vehicles serves various purposes, such as a heat pump system for cooling and heating and a battery cooling system. Generally, the heat exchange system includes major components, such as an electric compressor, a condenser, an expansion device, an evaporator, and an accumulator, and requires complex piping for the flow of refrigerant between these components. This leads to problems such as an increased number of parts, increased assembly labor, and increased refrigerant charge, resulting in higher costs and larger installation space in a vehicle.

In order to solve these problems, it is desirable to develop a compact heat exchange system configured such that the number of required components is reduced, unnecessary piping is eliminated, and piping length is minimized through modularization of the heat exchange system.

### Prior Art Documents

(Patent Document 1) Korean Patent Application Publication No. 10-2023-0011578 (Publication Date: 2023.01.25.)

(Patent Document 2) Korean Patent Application Publication No. 10-2020-0159463 (Publication Date: 2022.12.02.)

### Technical Problem

An aspect of the present disclosure is to provide a modular heat exchange system configured such that components constituting the heat exchange system are simply assembled, particularly a new type of modular heat exchange system with a simple and compact structure achieved by reducing or eliminating the number or length of pipes connecting the components.

Aspects of the present disclosure are not limited to the aforementioned aspect, and other unmentioned aspects will be clearly understood by those skilled in the art based on the following description.

### Technical Solution

A modular heat exchange system according to an embodiment of the present disclosure includes an electric compressor (11), a condenser (13), an expansion device (15), an evaporator (17), and a support structure (20) on which the components are directly or indirectly supported and fixed, wherein the support structure (20) includes a first support bracket (21), one side surface of each of the condenser (13) and the evaporator (17) is fastened and fixed to the first support bracket (21) so as to be supported thereby, the expansion device (15) is fastened and fixed to each of the condenser (13) and the evaporator (17) so as to be supported thereby, the expansion device (15) includes a block-shaped valve body (151) and an expansion valve (153) fluidically connected to the valve body (151), an internal flow path is formed in the valve body (151), and when the valve body (151) is assembled to each of the condenser (13) and the evaporator (17), each of the condenser (13) and the evaporator (17) is fluidically connected to the expansion valve (153) via the internal flow path of the valve body (151).

The first support bracket (21) may include a base portion (21a) fixed to a vehicle body and a vertical portion (21b) extending upward from the base portion (21a), wherein the vertical portion (21b) may be an H-shaped plate having a window (26) formed therein, the condenser (13) and the evaporator (17) may be disposed on one side of the vertical portion (21b), and the expansion device (15) may be disposed on the other side facing the condenser (13) and the evaporator (17) with the vertical portion (21b) interposed therebetween, and a part of the expansion device (15) may pass through the window (26) and be located on the one side.

The valve body (151) may include a first internal flow path (155) configured to allow refrigerant having passed through the condenser (13) to be supplied to the expansion valve (153) therethrough and a second internal flow path (156) configured to allow the refrigerant having passed through the expansion valve (153) to be supplied to the evaporator (17) therethrough.

The valve body (151) may be fastened to the condenser (13) and the evaporator (17) via a first intermediary member (61) and a second intermediary member (63), respectively, a first refrigerant pipe (33) and a second refrigerant pipe (35) may be formed so as to extend through the first intermediary member (61) and the second intermediary member (63), respectively, when the valve body (151) is assembled to the condenser (13) via the first intermediary member (61), the first refrigerant pipe (33) and the first internal flow path (155) may be hermetically coupled to connect the condenser (13) and the expansion valve (153) to each other, and when the valve body (151) is assembled to the evaporator (17) via the second intermediary member (63), the second refrigerant pipe (35) and the second internal flow path (156) may be hermetically coupled to connect the evaporator (17) and the expansion valve (153) to each other.

The support structure (20) may further include a second support bracket (23) disposed so as to face the first support bracket (21), the second support bracket being configured to support the other side surface of each of the condenser (13) and the evaporator (17).

The system (10) may further include an accumulator (19) fluidly connected to the evaporator (17) and the electric compressor (11), wherein the accumulator (19) may be coupled and fixed to the second support bracket (23) so as to be supported thereby and may be disposed in an inner space provided between the condenser (13) and the evaporator (17) at a height lower than the condenser (13) and the evaporator (17).

The support structure (20) may further include a third support bracket (25) disposed opposite the second support bracket (23) relative to the first support bracket (21), the third support bracket (25) may be fastened and fixed to the first support bracket (21), and the electric compressor (11) may be supported by the third support bracket (25) and disposed opposite the condenser (13) and the evaporator (17) relative to the expansion device (15).

The refrigerant discharged from the evaporator (17) may be supplied to the accumulator (19) via a first refrigerant tube (37), and the refrigerant discharged from the accumulator (19) may be introduced into the electric compressor (11) via a second refrigerant tube (39), and the first refrigerant tube (37) and the second refrigerant tube (39) may be located in the inner space between the condenser (13) and the evaporator (17) at a height lower than an upper end of each of the condenser (13) and the evaporator (17).

A front end of the first refrigerant tube (37) may extend toward the inner space from a connection portion (22) provided at one side surface of the evaporator (17), and a rear end of the second refrigerant tube (39) may pass through the inner space and may be bent and may extend toward an inlet side of the electric compressor (11), wherein the front end of the first refrigerant tube (37) and the rear end of the second refrigerant tube (39) may not extend beyond circumferential outsides of the evaporator (17) and the electric compressor (11).

### Advantageous Effects

According to the present disclosure, it is possible to minimize the overall size of a modular heat exchange system, to reduce the weight of the system by eliminating or minimizing piping, and to minimize the refrigerant charge.

In particular, conventional tubes that fluidically connect an expansion valve, a condenser, and an evaporator to each other are eliminated, a valve body having an internal flow path that fluidically connects the condenser and the evaporator to the expansion valve is provided instead thereof, and the condenser and the evaporator are connected to the expansion valve by assembling the valve body, thereby providing the advantage of simplifying a complex connection structure associated with using tubes.

The effects of the present disclosure are not limited to the above effects, but are to be understood to include all effects that can be inferred from the detailed description of the present disclosure or from the configuration of the present disclosure described in the claims.

### DESCRIPTION OF DRAWINGS

FIG. 1 is a perspective view of a modular heat exchange system according to an embodiment of the present disclosure.

FIG. 2 is another perspective view of the modular heat exchange system according to the embodiment of the present disclosure.

FIG. 3 is a bottom perspective view of the modular heat exchange system according to the embodiment of the present disclosure.

FIG. 4 is a plan view of the modular heat exchange system according to the embodiment of the present disclosure.

FIG. 5 is a perspective view of the modular heat exchange system according to the embodiment of the present disclosure with an electric compressor and a third bracket removed.

FIG. 6 is a plan view of a condenser, an expansion device, and an evaporator of the modular heat exchange system according to the embodiment of the present disclosure.

FIG. 7 is a perspective view of the expansion device of the modular heat exchange system according to the embodiment of the present disclosure.

FIG. 8 is an exploded perspective view of the expansion device of the modular heat exchange system according to the embodiment of the present disclosure.

FIG. 9 is a view illustrating the flow of refrigerant in the expansion device of the modular heat exchange system according to the embodiment of the present disclosure.

FIG. 10 is a view showing a support structure of the modular heat exchange system according to the embodiment of the present disclosure.

FIG. 11 is a conceptual view of the modular heat exchange system according to the embodiment of the present disclosure.

### BEST MODEL

Hereinafter, an embodiment of the present disclosure will be described in detail with reference to the accompanying drawings such that those skilled in the art to which the present disclosure pertains may easily implement the present disclosure. However, the present disclosure may be implemented in various different forms and is not limited to the embodiment described herein.

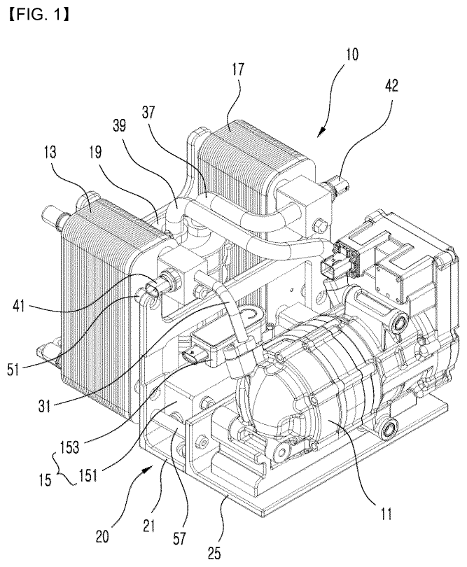

A modular heat exchange system 10 according to an embodiment of the present disclosure is configured to perform heat exchange with a target medium, such as a coolant, through a thermodynamic cycle of refrigerant. The modular heat exchange system 10 is configured to perform a cycle including compression, condensation, expansion, and evaporation of the refrigerant. To this end, the modular heat exchange system 10 may include components constituting a refrigerant circuit, such as an electric compressor 11, a condenser 13, an expansion device 15, an evaporator 17, an accumulator 19, and a support structure 20 on which the components are directly or indirectly supported and fixed, as shown in FIG. 1. That is, the components constituting the modular heat exchange system 10 are installed on the support structure 20, thereby forming a modular system. Furthermore, pipes, tubes, and flow path forming members are provided to facilitate the flow of the refrigerant between these components, which will be described later.

The refrigerant flows through the electric compressor 11, the condenser 13, the expansion device 15, and the evaporator 17. The refrigerant discharged from the evaporator 17 passes through the accumulator 19 and is then supplied back to the electric compressor 11. The refrigerant undergoes this circulation cycle, during which the refrigerant exchanges heat with the coolant while being compressed, condensed, expanded, and evaporated.

The circulation cycle will be described in more detail with reference to FIG. 1. The electric compressor 11 compresses the refrigerant, generating high-temperature, high-pressure refrigerant in a gaseous state. The condenser 13 condenses the gaseous refrigerant into a liquid state through heat exchange, creating high-temperature, high-pressure liquid refrigerant, and may be implemented as a plate heat exchanger. The expansion device 15 reduces the pressure of the liquid refrigerant and expands the liquid refrigerant, creating low-temperature, low-pressure liquid refrigerant, and may be implemented as an expansion valve. The evaporator 17 evaporates the refrigerant through heat exchange, and may be implemented as a plate heat exchanger. The evaporator 17 may be configured to evaporate the refrigerant through heat exchange between the refrigerant and the coolant. At this time, the evaporator 17 absorbs heat from the coolant to cool the coolant, and therefore the evaporator is also referred to as a chiller. The accumulator 19 is installed between the evaporator 17 and the electric compressor 11 to prevent the liquid refrigerant mixed with the gaseous refrigerant introduced from the evaporator 17 from entering the electric compressor 11.

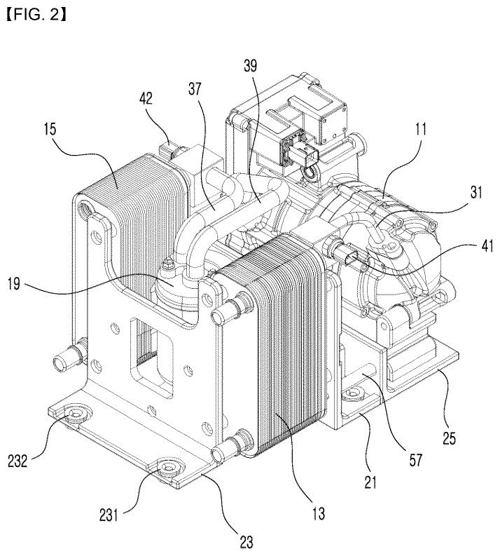

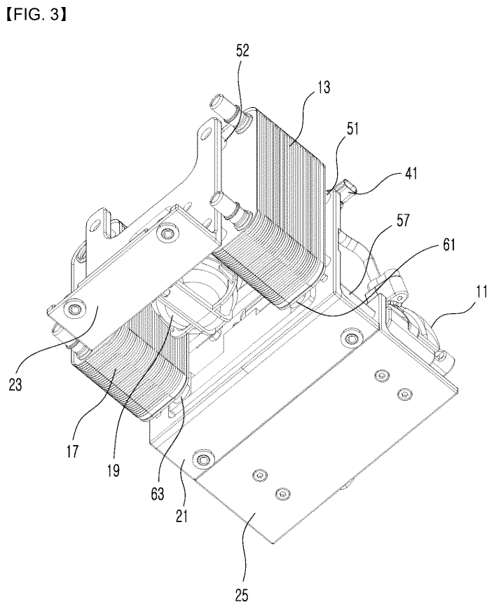

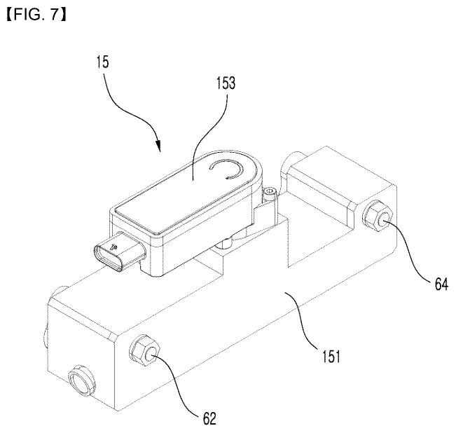

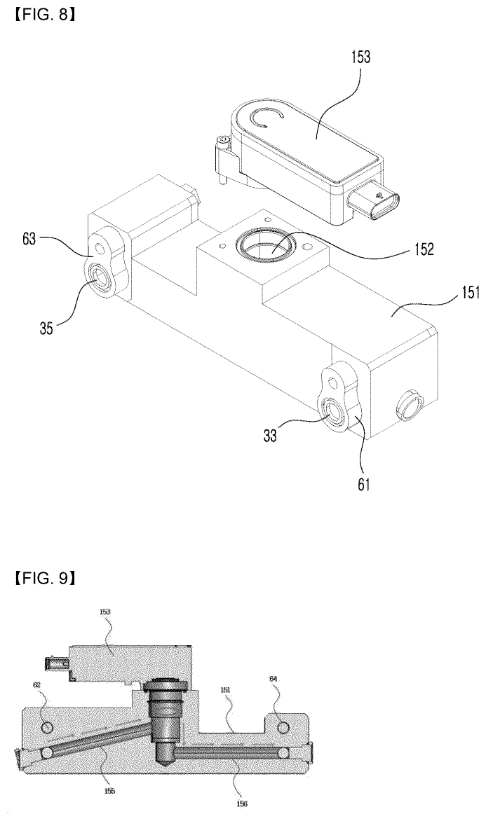

A piping structure for refrigerant flow between the electric compressor 11, the condenser 13, the expansion device 15, the evaporator 17, and the accumulator 19 will be described with reference to FIGS. 1 to 4 and 11. First, the refrigerant L1 compressed by the electric compressor 11 is supplied to the condenser 13 via a third refrigerant tube 31. The refrigerant L2, condensed into a liquid state through heat exchange with the coolant in the condenser 13, is supplied to the expansion device 15, and the refrigerant L3 discharged from the expansion device 15 is supplied to the evaporator 17. At this time, as described later, the condenser 13 and the expansion device 15 are physically connected via a first intermediary member 61, and the expansion device 15 and the evaporator 17 are physically connected via a second intermediary member 63. Furthermore, the expansion device 15 may include a block-shaped valve body 151 forming a refrigerant passageway and an expansion valve 153 connected thereto, wherein the valve body 151 may be fluidically connected to the condenser 13 via a first refrigerant pipe 33 shown in FIG. 8 and may be fluidically connected to the evaporator 17 via a second refrigerant pipe 35. Referring to FIG. 9, the valve body 151 may include a first internal flow path 155 configured to fluidically connect the first refrigerant pipe 33 and the expansion valve 153 to each other and a second internal flow path 156 configured to connect the expansion valve 153 and the second refrigerant pipe 35 to each other. The refrigerant discharged from the evaporator 17 is supplied to the accumulator 19 via the first refrigerant tube 37, and the refrigerant discharged from the accumulator 19 is introduced into the electric compressor 11 via the second refrigerant tube 39.

A first pressure/temperature (PT) sensor 41 and a second PT sensor 42 configured to detect the pressure and temperature of the refrigerant may be provided. The first PT sensor 41 may be installed in a third refrigerant tube 31 configured to connect the electric compressor 11 and the condenser 13 to each other to detect the pressure and temperature of the refrigerant introduced into the condenser 13, and the second PT sensor 42 may be installed in the first refrigerant tube 37 configured to connect the evaporator 17 and the accumulator 19 to each other to detect the pressure and temperature of the refrigerant discharged from the evaporator 17.

According to the embodiment of the present disclosure, the electric compressor 11, the condenser 13, the expansion device 15, the evaporator 17, and the accumulator 19 are supported by the support structure 20 and disposed so as to minimize piping and simplify the structure. The support structure 20 is configured to support these components and may be fixed to a vehicle body. Hereinafter, a detailed description thereof will be given.

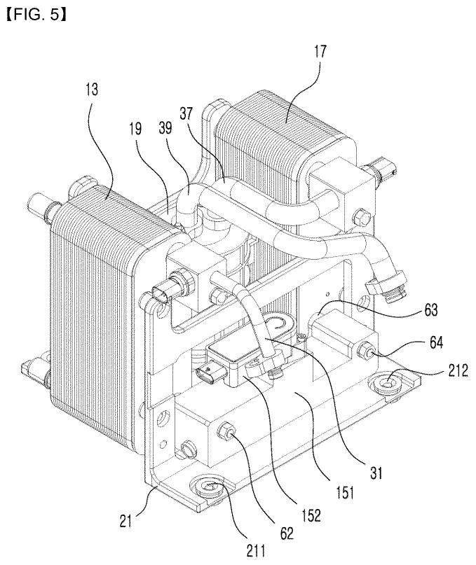

As shown in FIG. 1, the support structure 20 includes a first support bracket 21 configured to support the condenser 13 and the evaporator 17. The first support bracket 21 includes a base portion 21a fixed to the vehicle body and a vertical portion 21b extending upward from the base portion 21a, as shown in FIGS. 5 or 10.

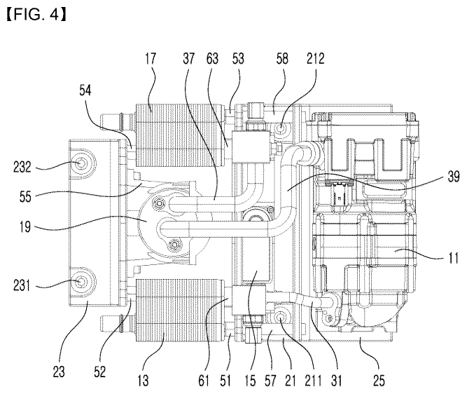

Fastening holes 211 and 212 (see FIG. 5) are provided in the base portion 21a of the first support bracket 21, enabling the first support bracket 21 to be fixed to the vehicle body. Furthermore, one side surface of each of the condenser 13 and the evaporator 17 is fastened and fixed to the vertical portion 21b of the first support bracket 21 so as to be supported thereby. The condenser 13 and the evaporator 17 are disposed near the first support bracket 21 in a state of being aligned parallel to each other with a gap therebetween, are fastened to the vertical portion 21b of the first support bracket 21 via fastening rods 51 and 53 so as to be supported thereby. Referring to FIG. 4, one side surface of each of the condenser 13 and the evaporator 17 refers to a surface where a corresponding one of the fastening rods 51 and 53 is provided.

The vertical portion 21b of the first support bracket 21 extends upward from the base portion 21a, and may be an H-shaped plate including a pair of vertical bars extending vertically upward from both ends of the base portion 21a in a width (W) direction and a horizontal bar configured to connect the vertical bars to each other. One side surface of the condenser 13 and one side surface of the evaporator 17 are fixed respectively to the pair of vertical bars so as to be supported thereby, and the horizontal bar is provided at upper ends of the pair of vertical bars to impart rigidity to the vertical bars. As shown in FIG. 10, etc., an open window 26 is provided between the vertical bars and the horizontal bar.

The expansion device 15 is fastened and fixed to the condenser 13 and the evaporator 17 so as to be supported thereby. As shown in FIG. 4, the expansion device 15 is disposed between the condenser 13, the evaporator 17, and the electric compressor 11. Referring to FIG. 4, the condenser 13 and the evaporator 17 are disposed on one side of the vertical portion 21b of the first support bracket 21, and are disposed side by side with a certain distance therebetween.

As shown in FIG. 1, a part of the expansion device 15 may pass through the window 26 in the vertical portion 21b and be located on one side of the vertical portion 21b. According to the embodiment of the present disclosure, the expansion device 15 is designed to be fixed in position by being fastened to the condenser 13 and the evaporator 17 rather than being directly fastened to the first support bracket 21. Referring to FIG. 6, when the condenser 13 and the evaporator 17 are mounted respectively on the pair of vertical bars constituting the vertical portion 21b of the first support bracket 21, the expansion device 15 is positioned on the other side facing the condenser and the evaporator. However, the pair of vertical bars of the first support bracket 21 is spaced apart from each other with a gap therebetween, and therefore, in the embodiment of the present disclosure, a part of the expansion device 15 may pass through the window 26 formed by the gap and be located on one side. According to this arrangement, it is possible to miniaturize the modular heat exchange system 10 by shortening the arrangement length of the components in a length (L) direction perpendicular to the width (W) direction of the base portion 21a of the first support bracket 21. Furthermore, the expansion device 15 serves to support the condenser 13 and the evaporator 17, unlike general tubes or pipes, while connecting the condenser 13 and the evaporator 17 to each other. Consequently, as shown in FIG. 6, the condenser 13 and the evaporator 17 connected to the expansion device 15 are fixed in a state of being spaced apart from each other, and therefore the condenser 13 and the evaporator 17 may be easily assembled to the first support bracket 21 and the second support bracket 23.

The expansion device 15 includes a block-shaped valve body 151 and an expansion valve 153 fluidically connected to the valve body 151. Referring to FIG. 9, the expansion valve 153 is a unit in which a motor and a gear are disposed, and the valve body 151 is coupled to a lower end of the expansion valve 153. Fluid movement and expansion actually occur in the valve body 151. Next, the physical and fluidic connection relationship between the valve body 151, the condenser 13, and the evaporator 17 will be described.

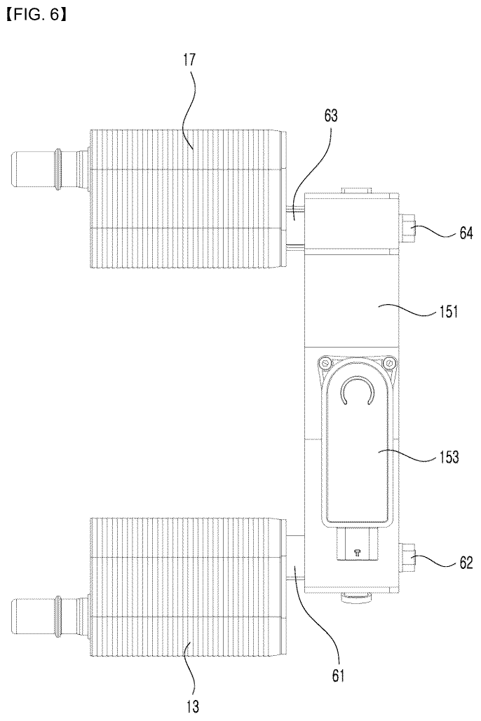

As shown in FIG. 6, the valve body 151 and the condenser 13 are physically connected via the first intermediary member 61, and the valve body 151 and the evaporator 17 are physically connected via the second intermediary member 63. Specifically, referring to FIGS. 7 and 8, the first intermediary member 61 and the second intermediary member 63 are provided on an outer surface of the valve body 151, and fastening members 62 and 64 are inserted into and fastened to the condenser 13 and the evaporator 17 through the valve body 151, the first intermediary member 61, and the second intermediary member 63. Referring to FIG. 6, since the valve body 151 is disposed adjacent to the condenser 13 and the evaporator 17, the first intermediary member 61 and the second intermediary member 63 configured to physically connect the condenser and the evaporator to each other are substantially very short in length. For example, the minimum distance by which the condenser 13 and the evaporator 17 are spaced apart from one side surface of the first support bracket 21 corresponds to the length of each of the fastening rods 51 and 53, and when the valve body 151 is disposed facing the other side surface of the first support bracket 21, the distance by which the condenser 13 and the evaporator 17 are spaced apart from the valve body 151 will be the sum of the length of each of the fastening rods 51 and 53 and the width of the first support bracket 21. In this case, the length of each of the first intermediary member 61 and the second intermediary member 63 correspond to the sum. Since a part of the expansion device 15 may extend beyond the window 26 and be disposed on one side, as described above, the length of each of the first intermediary member 61 and the second intermediary member 63 may be less than the sum.

As shown in FIG. 6, the first intermediary member 61 is disposed offset toward the inside of the condenser 13 in the width direction, and the second intermediary member 63 is disposed offset toward the inside of the evaporator 17 in the width direction. This may provide space for coupling the vertical portion 21b of the first support bracket 21 to outer surfaces of the condenser 13 and the evaporator 17 in the width direction, and therefore the valve body 151 may be disposed in the window 26 in the vertical portion 21b, enabling denser and secure coupling between the condenser 13, the evaporator 17, the first support bracket 21, and the valve body 151.

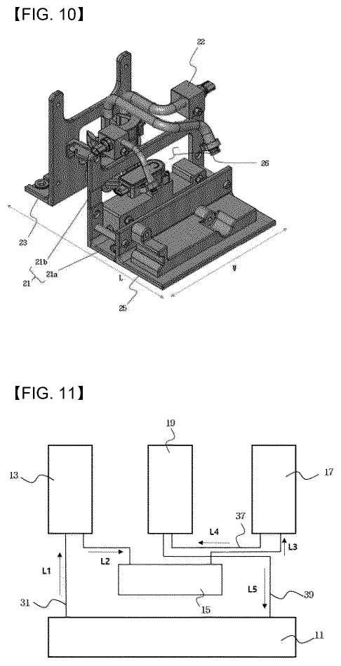

As shown in FIG. 11, the refrigerant L2 condensed into a liquid state in the condenser 13 is supplied to the expansion device 15, and the refrigerant L3 discharged from the expansion device 15 is supplied to the evaporator 17. Fluidic connection between these components is achieved by the first refrigerant pipe 33 and the second refrigerant pipe 35. That is, the condenser 13 may be fluidically connected to the valve body 151 via the first refrigerant pipe 33, and the valve body 151 may be fluidically connected to the evaporator 17 via the second refrigerant pipe 35. The first refrigerant pipe 33 and the second refrigerant pipe 35 are formed through the first intermediary member 61 and the second intermediary member 63, respectively. Referring back to FIG. 8, separate holes are formed under the holes formed through the first fastening member 62 and the second fastening member 64, and the first refrigerant pipe 33 and the second refrigerant pipe 35 penetrate the first intermediary member 61 and the second intermediary member 63 through the separate holes, respectively. In this structure, when the valve body 151 is physically coupled to the condenser 13 and the evaporator 17, fluid communication is achieved through the first refrigerant pipe 33 and the second refrigerant pipe 35.

As such, in the present disclosure, a flexible pipe (tube) of a certain length generally used for fluidic connection between the condenser 13, the evaporator 17, and the expansion device 15 is eliminated, and the intermediary members 61 and 63 having the first refrigerant pipe 33 and second refrigerant pipe 35 embedded therein are used instead thereof. This structure offers the advantage of simplifying the construction by eliminating the pipe (tube) and achieving fluidic connection between the components through simple assembly.

As shown in FIG. 9, fluid movement in the valve body 151 is achieved through the first internal flow path 155 and the second internal flow path 156. That is, internal flow paths are formed in the valve body 151, and therefore, when the valve body 151 is assembled to each of the condenser 13 and the evaporator 17, the condenser 13 and the evaporator 17 may be fluidically connected to the expansion valve 153 via the internal flow paths. More specifically, the valve body 151 includes a first internal flow path 155 configured to allow the refrigerant that has passed through the condenser 13 to be supplied to the expansion valve 153 therethrough and a second internal flow path 156 configured to allow the refrigerant that has passed through the expansion valve 153 to be supplied to the evaporator 17 therethrough. Although not shown in FIG. 8, the first refrigerant pipe 33 fluidically communicates with the first internal flow path 155 provided in the valve body 151 after extending through the first intermediary member 61, and the second refrigerant pipe 35 fluidically communicates with the second internal flow path 156 provided in the valve body 151 after extending through the second intermediary member 63.

The first refrigerant pipe 33 is fluidically connected to the condenser 13. When the valve body 151 is assembled to the condenser 13 via the first intermediary member 61, the condenser 13, the first refrigerant pipe 33, and the first internal flow path 155 are hermetically coupled to each other, whereby the condenser 13 and the expansion valve 153 are connected to each other. The second refrigerant pipe 35 is fluidically connected to the evaporator 17. When the valve body 151 is assembled to the evaporator 17 via the second intermediary member 63, the evaporator 17, the second refrigerant pipe 35, and the second internal flow path 156 are hermetically coupled to each other, whereby the evaporator 17 and the expansion valve 153 are connected to each other.

According to this configuration, the condenser 13 and the evaporator 17 are connected to the expansion valve 153 by mounting the condenser 13 and the valve body 151, which has an internal flow path fluidically connecting the expansion valve 153 and the evaporator 17 to each other, on the expansion valve 153. This eliminates a complex connection structure required when applying a tube to fluidically connect the expansion valve 153, the condenser 13, and the evaporator 17 to each other and provides the advantage of simplifying the fluidic connection between the components. Furthermore, since the structure for fastening the valve body 151 to the condenser 13 and the evaporator 17 is simple, fluidic communication may be achieved through easy assembly.

As described above, the valve body 151 includes a first internal flow path 155 and a second internal flow path 156 for the flow of the refrigerant. The first internal flow path 155 communicates with the first refrigerant pipe 33, is fluidically connected to the condenser 13, and is fluidically connected to the expansion valve 153. The second internal flow path 156 is fluidically connected to the expansion valve 153, and is fluidically connected to the evaporator 17. Since the first refrigerant pipe 33 and the second refrigerant pipe 35, which form the refrigerant passageway, extend through the intermediary members 61 and 63 for fastening the valve body 151 to the condenser 13 and the evaporator 17, the piping structure is significantly simplified. The first internal flow path 155 and the second internal flow path 156 may be formed in the block-shaped valve body 151 by machining, and plugs 161 and 163 may be assembled to block holes into which tools for machining are inserted. As shown in FIG. 9, the expansion valve 153 is inserted into and coupled to the valve body 151 from above. For proper function of the expansion valve 153, the inlet side of the expansion valve 153 is disposed higher than the outlet side of the expansion valve 153. Consequently, one end of the first internal flow path 155 formed in the valve body 151 is connected to the expansion valve 153 at a higher position than one end of the second internal flow path 156. The other end of the first internal flow path 155 is connected to the first refrigerant pipe 33 shown in FIG. 8 and thus is connected to the condenser 13.

A refrigerant inlet and a refrigerant outlet of the condenser 13 must be spaced apart from each other to allow the refrigerant to sufficiently pass through the condenser 13. To this end, it is desirable for the other end of the first internal flow path 155 to be located lower than one end of the first internal flow path 155.

As shown in FIG. 8, the first internal flow path 155 formed in the valve body 151 may be formed straight with a predetermined slope from a lower surface of the valve body 151. This enables the formation of the first internal flow path 155 through minimal machining.

As shown in FIG. 8, one end of the second internal flow path 156 is connected to the expansion valve 153 at a lower position than the first internal flow path 155. In the same manner as the condenser 13, the other end of the second internal flow path 156 is connected to the second refrigerant pipe 35 at the same height as the other end of the first internal flow path 155 and thus is connected to the evaporator 17 such that the refrigerant sufficiently passes through the evaporator 17.

The second internal flow path 156 is formed parallel to the lower surface of the valve body 151, unlike the first internal flow path 155. As shown in FIG. 9, removing a part of the valve body 151 located above the second internal flow path 156 allows the volume and weight of the valve body 151 to be reduced.

The support structure 20 may further include a second support bracket 23 configured to additionally support the condenser 13 and the evaporator 17. The second support bracket 23 is disposed so as to face the first support bracket 21 and supports the other side surface of each of the condenser 13 and the evaporator 17. The condenser 13 and the evaporator 17 may be fastened to the second support bracket 23 via fastening rods 52 and 54, respectively, so as to be supported thereby, and the second support bracket 23 may be fixed to the vehicle body through fastening holes 231 and 232.

As shown in FIG. 10, according to the embodiment of the present disclosure, the second support bracket 23 is provided as a separate component from the first support bracket 21, whereby the first support bracket 21 and the second support bracket 23 are separated from each other. According to this design, the components may be sequentially assembled in a predetermined order to manufacture the entire heat exchange system 10, whereby easy assembly is achieved.

As shown in FIG. 10, one side surface of each of the condenser 13 and the evaporator 17 is mounted on the first support bracket 21, and the other side surface of each of the condenser 13 and the evaporator 17 is supported using the second support bracket 23. Consequently, even when the condenser 13 and evaporator 17 are disposed spaced apart from each other in order to minimize thermal influence therebetween, the condenser 13 and evaporator 17 may be securely supported.

Specifically, since the first support bracket 21 and the second support bracket 23 supporting the condenser 13 and the evaporator 17 are separately formed, as shown in FIG. 10, even when condensers 13 and evaporators 17 of different specifications are used, the first support bracket 21 and the second support bracket 23 may be coupled to the condenser 13 and the evaporator 17, thereby enhancing compatibility.

For example, as in the embodiment of the present disclosure, each of the condenser 13 and the evaporator 17 may be a plate heat exchanger. In the plate heat exchanger, the number of plates may be increased or decreased according to the required performance. That is, the length of each of the condenser 13 and evaporator 17 may be increased or decreased in a predetermined direction. Considering such a case, as shown in FIG. 10, the second support bracket 23, provided as a separate component from the first support bracket 21, is independently fastened to the vehicle body, which allows the distance between the first support bracket 21 and the second support bracket 23 in the L direction to be adjusted. Even if the position of the other side surface of each of the condenser 13 and the evaporator 17 changes, therefore, the second support bracket 23 may be installed on the vehicle body so as to correspond to the changed position, thereby supporting the other side surface of each of the condenser and the evaporator. Consequently, providing the second support bracket 23 separately facilitates adaptation to changes in size of the heat exchanger.

As shown in FIG. 1, the modular heat exchange system 10 may further include an accumulator 19 fluidically connected to the evaporator 17 and the electric compressor 11. The accumulator 19 may be cylindrical in shape. As shown in FIG. 11, the refrigerant L4 discharged from the evaporator 17 is supplied to the accumulator 19 via the refrigerant tube 37, and the refrigerant L5 discharged from the accumulator 19 is introduced into the electric compressor 11 via the refrigerant tube 39. The accumulator 19 serves to prevent the liquid refrigerant mixed with the gaseous refrigerant that has flown from the evaporator 17 between the evaporator 17 and the electric compressor 11 from entering the electric compressor 11.

The accumulator 19 is disposed between the condenser 13 and the evaporator 17, as shown in FIG. 4. The accumulator 19 may be fixed to the vehicle body, fixed to the first support bracket 21, or, as in the embodiment of the present disclosure, may be coupled and fixed to the second support bracket 23 so as to be supported thereby. More specifically, the condenser 13 and the evaporator 17 are fixed to the vertical bars 21b of the first support bracket 21, respectively. Since the vertical bars 21b are disposed spaced apart from each other in the longitudinal direction, an inner space is provided between the condenser 13 and the evaporator 17. According to the embodiment of the present disclosure, the condenser 13 and the evaporator 17 are disposed spaced apart from each other to prevent thermal interference therebetween, and the accumulator 19 is disposed in the inner space between the condenser 13 and the evaporator 17, whereby space efficiency is maximized without provision of a separate space.

Furthermore, since the accumulator 19 is fixed to the second support bracket 23 that supports the other side surface of each of the condenser 13 and the evaporator 17, an additional bracket for supporting the accumulator is not needed. Alternatively, the accumulator 19 may be disposed between the condenser 13 and the evaporator 17 and may be coupled and fixed to the first support bracket 21 so as to be supported thereby. For example, the accumulator 19 may be fixed to the horizontal bar of the first support bracket 21 so as to be supported thereby.

As shown in FIG. 10, according to the embodiment of the present disclosure, the accumulator 19 is disposed in an empty space between the condenser 13 and the evaporator 17. In order to minimize thermal interference and to secure the empty space, it is desirable to dispose the condenser 13 and the evaporator 17 so as to be spaced as far apart from each other as possible in the width (W) direction. However, as shown in FIG. 4, it is desirable to dispose the condenser 13 and the evaporator 17 so as to be spaced apart from each other such that the outmost sides of the condenser and the evaporator do not extend beyond the width W of the first support bracket 21. This allows the outermost sides of the condenser 13 and the evaporator 17 to form the outermost peripheries in the width (W) direction, defining the width of the modular heat exchange system 10. That is, the modular heat exchange system 10 may be readily disposed in a predetermined space in the vehicle.

As shown in FIG. 1, the accumulator 19 is disposed in the inner space provided between the condenser 13 and the evaporator 17 at a height lower than an upper end of each of the condenser 13 and the evaporator 17.

Fluid movement between the accumulator 19, the evaporator 17, and the electric compressor 11 is achieved through the first refrigerant tube 37 and the second refrigerant tube 39. That is, the refrigerant L4 discharged from the evaporator 17 is supplied to the accumulator 19 via the first refrigerant tube 37, and the refrigerant L5 discharged from the accumulator 19 is introduced into the electric compressor 11 via the second refrigerant tube 39. As shown in FIG. 1, each of the first refrigerant tube 37 and the second refrigerant tube 39 extends while being bent at one or more positions. The first refrigerant tube 37 and the second refrigerant tube 39 are disposed in the inner space between the condenser 13 and the evaporator 17 at a height lower than the upper end of each of the condenser 13 and the evaporator 17. A front end of the first refrigerant tube 37 extends toward the inner space from a connection portion 22 provided at one side surface of the evaporator 17, and a rear end of the second refrigerant tube 39 passes through the inner space and is bent and extends toward the inlet side of the electric compressor 11, wherein the front end of the first refrigerant tube 37 and the rear end of the second refrigerant tube 39 are designed so as not to extend beyond circumferential outsides of the evaporator and the electric compressor.

According to this configuration, the accumulator 19, the first refrigerant tube 37, and the second refrigerant tube 39 do not protrude outside the inner space, and the ends of the first refrigerant tube 37 and the second refrigerant tube 39 do not protrude beyond the circumferential outsides of the evaporator 17 and the electric compressor 11, whereby the modular heat exchange system 10 may be implemented in a more compact manner.

According to the embodiment of the present disclosure, as shown in FIG. 1, the support structure 20 may further include a third support bracket 25 fastened and fixed to the first support bracket 21 and configured to support the electric compressor 11. The third support bracket 25 may be disposed opposite the second support bracket 23 relative to the first support bracket 21, and may be fixed to the first support bracket 21 via fastening members 57 and 58 while being disposed near the first support bracket 21. Consequently, the electric compressor 11 is supported by the third support bracket 25, and is disposed opposite the condenser 13 and the evaporator 17 relative to the expansion device 15. As the third support bracket 25 is provided separately from the first support bracket 21, as described above, replacement of the entire support structure 20 is not needed even when electric compressors 11 of different specifications are used according to required standards, whereby it is possible to enhance compatibility. Furthermore, the first support bracket 21, the condenser 13, and the evaporator 17 may be coupled to each other be assembled without the third support bracket 25 being coupled, whereby sufficient working space may be provided to an operator.

In another embodiment of the present disclosure, the electric compressor 11 may be directly supported by the vehicle body instead of being supported by a separate support bracket. The modular heat exchange system according to the embodiment of the present disclosure is designed to have a structure that is simple to assemble, compact, and minimizes piping. By utilizing the first support bracket to the third support bracket for assembling the components, the components mounted on the support bracket may be disposed in a space-efficient manner. This design also enhances compatibility, allowing the components to be replaced with components of different specifications, and facilitates easy assembly by the operator. Furthermore, unnecessary piping is eliminated, and the required length of piping is minimized. Consequently, the required refrigerant charge may be reduced, and the system weight may be decreased.

Although the embodiment of the present disclosure has been described above in detail, the scope of the present disclosure is not limited thereto, and various modifications and improvements by those skilled in the art utilizing the basic concepts of the present disclosure defined in the following claims are also within the scope of the present disclosure.

1. A modular heat exchange system comprising an electric compressor, a condenser, an expansion device, and an evaporator, the modular heat exchange system being coupled to a vehicle body, the modular heat exchange system comprising:
a support structure configured to directly or indirectly support the electric compressor, the condenser, the expansion device, and the evaporator, wherein
the support structure comprises a first support bracket,
one side of each of the condenser and the evaporator is fastened and fixed to the first support bracket so as to be supported thereby,
the expansion device is fastened and fixed to each of the condenser and the evaporator so as to be supported thereby,
the expansion device comprises a block-shaped valve body having an internal flow path formed therein and an expansion valve fluidically connected to the valve body, and
as the valve body is assembled to the condenser and the evaporator, the condenser and the evaporator fluidically communicate with the expansion valve via the internal flow path of the valve body.

2. The modular heat exchange system as claimed in claim 1, wherein
the first support bracket comprises a base portion fixed to the vehicle body and a vertical portion extending from the base portion in one direction,
a window is formed through an inside of the vertical portion,
the condenser and the evaporator are disposed on one side of the vertical portion, and
one end of the expansion device is disposed through the window.

3. The modular heat exchange system as claimed in claim 1, wherein the valve body comprises:
a first internal flow path configured to allow refrigerant having passed through the condenser to be supplied to the expansion valve therethrough; and
a second internal flow path configured to allow the refrigerant having passed through the expansion valve to be supplied to the evaporator therethrough.

4. The modular heat exchange system as claimed in claim 3, wherein one end of the first internal flow path connected to the expansion valve is disposed spaced apart from one surface of the valve body by a greater distance than one end of the second internal flow path connected to the expansion valve.

5. The modular heat exchange system as claimed in claim 4, wherein the other end of the first internal flow path and the other end of the second internal flow path are located at the same vertical distance from the one surface of the valve body.

6. The modular heat exchange system as claimed in claim 3, wherein a predetermined angle is formed between an extension direction of the first internal flow path and an extension direction of the second internal flow path.

7. The modular heat exchange system as claimed in claim 3, wherein one side of the valve body in which the second internal flow path is formed is depressed toward the first support bracket.

8. The modular heat exchange system as claimed in claim 1, wherein
the valve body is fastened to the condenser and the evaporator via a first intermediary member and a second intermediary member, respectively,
a first refrigerant pipe and a second refrigerant pipe are formed so as to extend through the first intermediary member and the second intermediary member, respectively,
when the valve body is assembled to the condenser via the first intermediary member, the first refrigerant pipe and the first internal flow path are hermetically coupled to connect the condenser and the expansion valve to each other, and
when the valve body is assembled to the evaporator via the second intermediary member, the second refrigerant pipe and the second internal flow path are hermetically coupled to connect the evaporator and the expansion valve to each other.

9. The modular heat exchange system as claimed in claim 1, wherein the support structure further comprises a second support bracket configured to support each of the other side of the condenser and the other side of the evaporator.

10. The modular heat exchange system as claimed in claim 9, wherein the second support bracket is disposed so as to face the first support bracket with the condenser and the evaporator disposed therebetween.

11. The modular heat exchange system as claimed in claim 9, further comprising:
an accumulator fluidically connected to the evaporator and the electric compressor, wherein
the accumulator is coupled to the second support bracket.

12. The modular heat exchange system as claimed in claim 11, wherein a longitudinal direction of the accumulator is perpendicular to the vehicle body.

13. The modular heat exchange system as claimed in claim 9, wherein the accumulator is disposed between the condenser and the evaporator.

14. The modular heat exchange system as claimed in claim 9, wherein one end of the accumulator is disposed closer to the vehicle body than one end of the condenser and one end of the evaporator.

15. The modular heat exchange system as claimed in claim 14, wherein the accumulator is connected to the evaporator and the electric compressor via a first refrigerant tube and a second refrigerant tube coupled to one end of the accumulator, respectively.

16. The modular heat exchange system as claimed in claim 11, wherein
the support structure further comprises a third support bracket disposed opposite the second support bracket relative to the first support bracket,
the third support bracket is fastened and fixed to the first support bracket, and
the electric compressor is supported by the third support bracket and is disposed opposite the condenser and the evaporator relative to the expansion device.

17. The modular heat exchange system as claimed in claim 16, wherein a longitudinal direction of the electric compressor is parallel to a direction from the condenser to the evaporator.

18. The modular heat exchange system as claimed in claim 11, wherein
refrigerant discharged from the evaporator is supplied to the accumulator via a first refrigerant tube, and the refrigerant discharged from the accumulator is introduced into the electric compressor via a second refrigerant tube, and
the first refrigerant tube and the second refrigerant tube are located in an inner space between the condenser and the evaporator at a height lower than an upper end of each of the condenser and the evaporator.

19. The modular heat exchange system as claimed in claim 18, wherein
the first refrigerant tube extends from a connection portion (22) provided at one side surface of the evaporator toward the evaporator,
one end of the second refrigerant tube extends toward the evaporator while the other end of the second refrigerant tube is bent and extends toward an inlet side of the electric compressor, and
the first refrigerant tube and the second refrigerant tube are disposed respectively inside the evaporator and the electric compressor in a circumferential direction.
